(19) United States
(12) Patent Application Publication
(10) Pub. No.: US 2003/0178361 A1
(43) Pub. Date: Sep. 25, 2003

(54) Fuel filter made using a polyketone material

(76) Inventor: Timothy L. Memmer, Perrysburg, OH (US)

Correspondence Address: Honeywell International Inc., 101 Columbia Road, P.O. Box 2245, Morristown, NJ, 07962, US

(21) Appl. No.: 10/104,419

(22) Filed: Mar. 22, 2002

(51) Int. Cl. B01D 27/00; B01D 24/00; B01D 35/00

(52) U.S. Cl. 210/435; 210/446; 210/321.6; 210/500.1; 210/500.27

(57) ABSTRACT

A fluid filter includes a housing having an inlet, an outlet, and a center section. A filter element is disposed within the housing. The filter includes a portion made from a polyketone-containing material. The polyketone-containing portion may be the filter housing, the filter element, or both. Where the filter element is formed from a polyketone-containing material, it may be a porous block, a multiplicity of polyketone-containing beads, or a porous polyketone membrane.

### BACKGROUND OF THE INVENTION

1. Field of the Invention

The present invention relates to fluid filters. More particularly, the present invention relates to a fluid filter including a polyketone material. The filter hereof is usable as a fuel filter.

2. Description of the Background Art

Fuel filters are commonly used on vehicles, and are widely available. However, fuel filters have been conventionally made from materials having certain drawbacks. Metals have been commonly used for fuel filter housings.

Some plastics, particularly polyacetals and nylon, have been tried for fuel filter housings because of their strength, machinability, and resistance to degradation by fuels. However, acetals exhibit some tendency to be brittle, have little flexibility, and may be susceptible to cracking.

Nylon has limited chemical resistance in a hydrocarbon environment, and some permeation of hydrocarbons into nylon material may occur.

A variety of materials are used to form fuel filter elements. Sintered bronze has been used as a material for fuel filter elements, and treated filter paper is also known.

A variety of different polyketone materials are known. Polyketones have been sold under the trademark “CARILON” by the Shell Chemical company, and other polyketones are commercially available under the mark “KETONEX” from the Solvay company.

Examples of some of the known patents relating to polyketone materials include, United States Patent Re 36,793 to Barron et al., U.S. Pat. No. 5,232,968 to Davidson, and U.S. Pat. No. 5,714,574 to Cooley.

It has also been known to use polyketones to form a porous membrane, as described in U.S. Pat. No. 4,804,472 to Handlin. The entire disclosure of U.S. Pat. No. 4,804,472 to Handlin is incorporated by reference herein.

Although the known polyketones have some utility for their intended purposes, a need still exists in the art for an improved fuel filter incorporating polyketones therein. In particular, there is a need for a fuel filter which uses a polyketone for the filter housing.

### SUMMARY OF THE INVENTION

The present invention provides a fuel filter including a component made from a material which includes at least one polyketone. Preferred polyketones are aliphatic polyketones.

The fuel filter hereof may include a hollow filter housing formed from a polyketone-containing material.

Optionally, the filter according to the invention may incorporate a polyketone into the filter element thereof. Such a filter element may be a porous block. Alternatively, the filter element may include a multiplicity of plastic beads, which may be placed loose within the housing, or else may be joined together using heat or with an adhesive, with hollow spaces defined between the beads to allow fuel to pass therebetween.

In another embodiment, the filter element may include one or more porous polyketone membranes.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

FIG. 1 is an exploded perspective view of a fuel filter in accordance with a first embodiment of the present invention.

FIG. 2 is a cross-sectional view of the fuel filter of FIG. 1, with the housing sections shown spaced away from one another.

FIG. 3 is a cross-sectional view of the fuel filter of FIGS. 1-2, shown in an assembled configuration, with a welded seam on the housing.

FIG. 4 is a cross-sectional detail view of a section of the housing of FIG. 1, taken along a plane transverse to the longitudinal axis.

FIG. 5 is a perspective view of a fuel filter according to a second embodiment of the present invention, in which the filter element includes a multiplicity of plastic beads; and

FIG. 6 is a cross-sectional view of a filter housing according to a third embodiment of the present invention, showing a porous membrane extending across each housing section.

### DETAILED DESCRIPTION OF THE PRESENTLY PREFERRED EMBODIMENTS

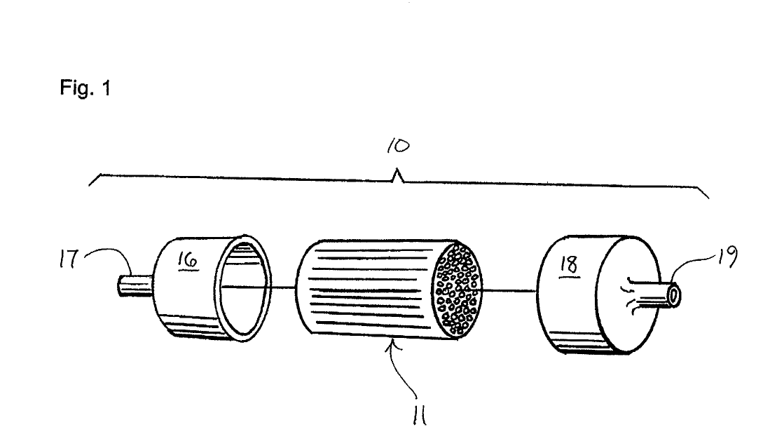

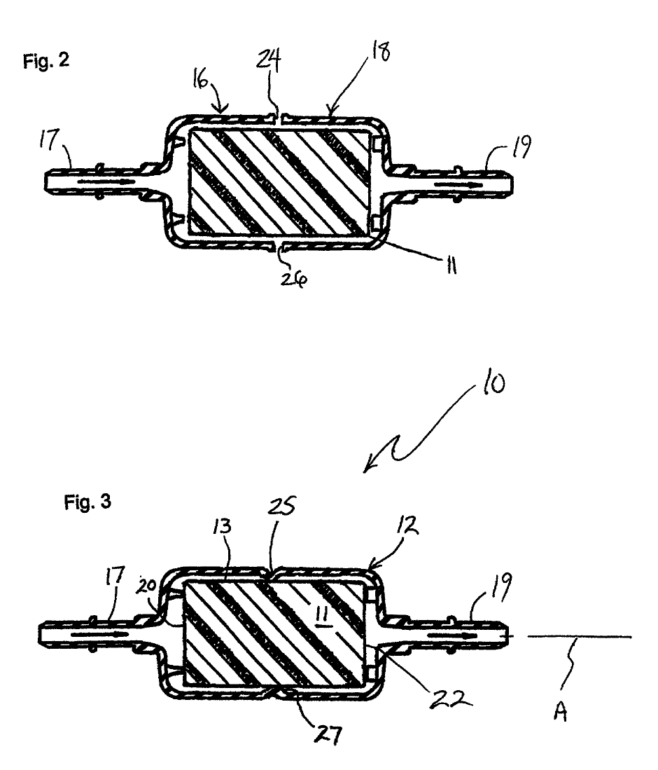

An exploded perspective view of a fluid filter 10, in accordance with a first embodiment of the invention, is shown in FIG. 1. The filter 10 is appropriate for use as a fuel filter in the illustrated embodiment. The filter 10 includes a hollow plastic housing 12 (FIG. 3), and a porous filter element 11 disposed within the housing.

The Housing

The shape of the housing 12 is conventional. In the practice of the present invention, the housing 12 is preferably formed of a material containing a polyketone, most preferably an aliphatic polyketone.

The housing 12 includes first and second housing shells 16, 18, which cooperate to substantially surround and enclose the filter element 11. The first housing shell 16 is provided with a hollow inlet tube 17 in fluid communication with the interior thereof, and the second housing shell 18 is provided with a hollow outlet tube 19 in fluid communication with the interior thereof. The first and second housing shells 16, 18 are alignable, in either nesting or edge-to-edge relation to form the housing 12. The adjoining edge portions 24, 26 of the housing shells 16, 18 are welded or glued together at a housing seam 25 to form the housing.

Optionally, the edge portions 24, 26 may be moved inwardly, when in a molten state, to form a fluid-resistant seal 27 surrounding the filter element 11, as shown in FIG. 3. The seal 27, where used, is formed between the seam area 25 of the housing and a side edge 13 of the filter element 11.

Alternatively, a separate fuel-stable sealing material may be provided to form a seal 27 between the housing 12 and the filter element 11, to force fuel to go primarily through the filter element 11, rather than around it.

Although the housing shells 16, 18 are shown in the drawings as being substantially the same length as one another, they may be made of different lengths from one another, as desired for a particular application. For example, the first housing shell 16 may be made to extend most of the length of the filter element 11, and the second housing shell 18 may be made correspondingly shorter. Changing the relative lengths of the shells 16, 18 will effectively move the location of the seam 25 on the housing, and will also move the location of the seal 27.

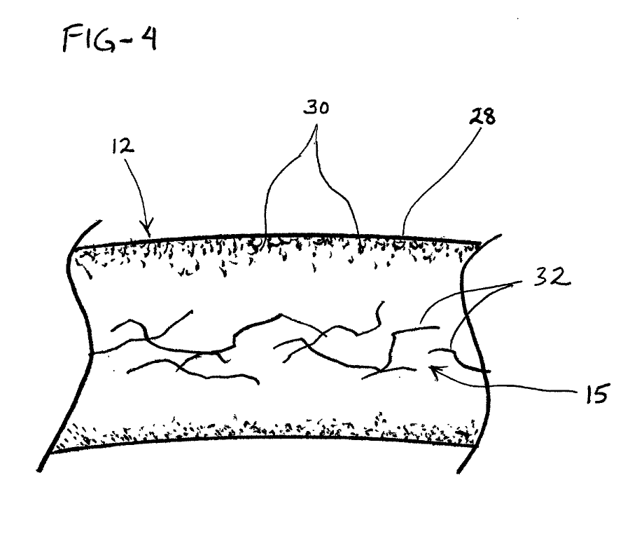

FIG. 4 is a cross-sectional detail view through a portion of the housing wall. As shown in FIG. 4, the housing 12 may be formed with one or more electrically conductive materials cast therein, such as carbon particles 30, stainless steel fibers 32, or both of these. The carbon particles tend to concentrate towards the outer surface 28 of the housing wall, while the stainless steel fibers tend to be located approximately in the central portion 15 of the housing wall. Where used, these electrically conductive materials 30, 32 are provided to preemptively avoid any static buildup in the filter housing, which might otherwise conceivably lead to a spark discharge, causing a possible risk of starting a fire. In practice, when the filter 10 is installed on a vehicle (not shown) it is preferred that the housing 12 be electrically connected to vehicle ground.

The Filter Element

The filter element 11 may be extruded plastic, or may be made otherwise porous. Optionally, the filter element 11 may also be formed of a material comprising a polyketone. In the embodiment of FIG. 3, it is preferred that the filtrate pass through the filter element 11 in a direction which is substantially linear and parallel to the longitudinal axis A thereof, although some of the filtrate entering through the sides of the filter element is acceptable.

The Flow Path

With reference to FIG. 3, one illustrative example of a possible flow path of the fluid filtrate begins when the filtrate enters the housing inlet 17. The fluid filtrate may then flow into a first porous end wall 20 of the filter element 11, where some impurities are removed. Some of the fluid filtrate may also flow around the filter element 11 and in through a side wall 13 thereof. However, the filtrate is blocked from bypassing the filter element by the seal 27 formed between the housing 12 and the filter element 11. The fluid filtrate passes in a substantially axial direction through the porous filter element, and then passes outwardly from a second end wall 22 adjacent the filter outlet 19, and then exits the filter 10 via the outlet. Other filter designs may have different flow paths from the example described here. The flow path is not a critical feature of the present invention.

Second Embodiment

Referring now to FIG. 5, an alternative embodiment of a fuel filter 110, in accordance with the present invention, is shown. The fuel filter 110 in this embodiment includes a housing 112, which is substantially similar to the housing 12 described above in connection with the first embodiment. The housing includes a narrow, tubular inlet 117, a center section 121 which defines a hollow chamber therein, and a narrow, tubular outlet 119.

However, in this embodiment, a filter element 111 is provided, which is made up of a multiplicity of plastic pellets or beads 115. The beads 115 may be held loosely inside the housing 112 or, alternatively, may be joined together, prior to assembly, by heat or by a suitable adhesive. The beads 115 define open spaces therebetween to allow fuel to flow therethrough.

These beads may be formed of a material comprising a polyacetal, nylon, a polyketone, or mixtures thereof. Preferably, the beads include a polyketone.

Third Embodiment

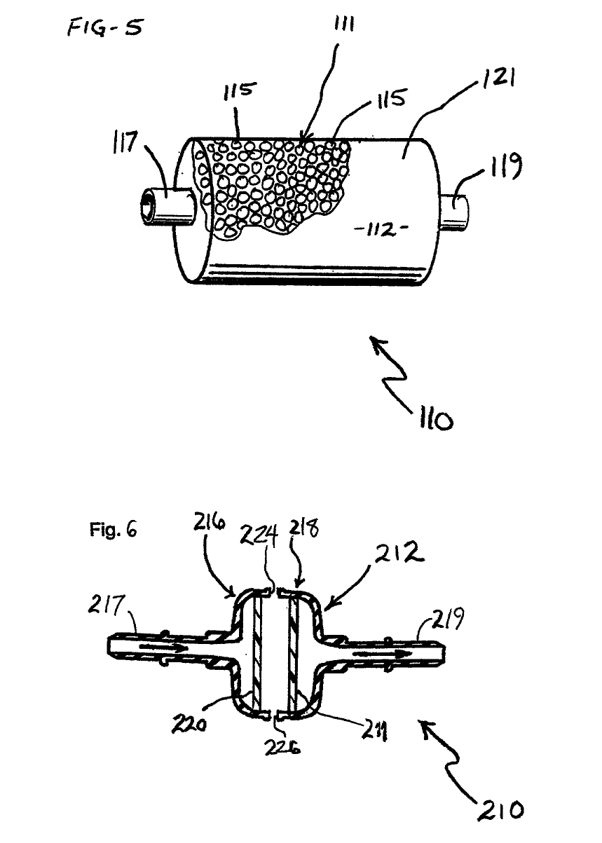

Referring now to FIG. 6, a fuel filter 210 according to a third embodiment of the invention is shown. The fuel filter 210 in this embodiment includes a housing 212 which is substantially similar to the housing 12 described above in connection with the first embodiment, except that the center section thereof is made shorter because the filter element 211 is significantly smaller.

The housing 212 includes first and second housing shells 216, 218, which cooperate to substantially surround and enclose two spaced apart filter elements 211, 220. The first housing shell 216 is provided with a hollow inlet tube 217 in fluid communication with the interior thereof, and the second housing shell 218 is provided with a hollow outlet tube 219 in fluid communication with the interior thereof. The first and second housing shells 216, 218 are alignable, in either nesting or edge-to-edge relation to form the housing 212.The adjoining edge portions 224, 226 of the housing shells 216, 218 are welded or glued together at a housing seam to form the housing 212.

In the embodiment of FIG. 6, a filter element 211 is provided in the form of a porous polyketone membrane. In this embodiment, the polyketone membrane is formed substantially in accordance with the teachings of U.S. Pat. No. 4,804,472, adapted for use as a liquid fuel filter. Optionally, but not necessarily, a second polyketone membrane 220 may also be provided in the housing 212 to provide added filtration.

Although the present invention has been described herein with respect to a preferred embodiment thereof, the foregoing description is intended to be illustrative, and not restrictive. Those skilled in the art will realize that many modifications of the preferred embodiment could be made which would be operable. All such modifications which are within the scope of the claims are intended to be within the scope and spirit of the present invention.

Having, thus, described the invention, what is claimed is:

1. A filter housing for a fluid filter, said filter housing comprising a hollow body having an inlet and an outlet;
said housing being made from a material comprising a polyketone.

2. A fluid filter, comprising:
a housing comprising a hollow body having an inlet and an outlet; said housing being made from a material comprising a polyketone; and
a filter element disposed within the housing and comprising a polyketone.

3. The fuel filter of claim 2, wherein said housing further comprises an electrically conductive material.

4. The fuel filter of claim 2, wherein said filter element comprises a porous block.

5. The fuel filter of claim 2, wherein said filter element comprises a multiplicity of plastic beads.

6. The fuel filter of claim 5, wherein said beads are held together in a fixed orientation thereof.

7. The fuel filter of claim 5, wherein said beads are loosely held within said housing.

8. The fuel filter of claim 2, wherein said filter element comprises at least one fluid-permeable membrane.

9. A fluid filter, comprising:
a housing comprising:
a first housing section having a tubular inlet and having a first hollow shell in fluid communication with said tubular inlet;
a second housing section having a tubular outlet and a second hollow shell in fluid communication with said tubular outlet, said second housing section being joined to said first housing section; and
a filter element disposed within said housing for filtering a fluid therethrough; wherein said filter element is formed from a material comprising a polyketone.

10. The fluid filter of claim 9, wherein the filter element comprises at least one fluid-permeable membrane extending across a selected one of said first and second housing sections.

11. The fuel filter of claim 9, wherein said housing further comprises an electrically conductive material.

12. The fuel filter of claim 9, wherein said filter element comprises a porous block.

13. The fuel filter of claim 9, wherein said filter element comprises a multiplicity of plastic beads.

14. The fuel filter of claim 13, wherein said beads are held together in a fixed orientation thereof.

15. The fuel filter of claim 13, wherein said beads are loosely held within said housing.

16. The fuel filter of claim 9, wherein said housing is also formed from a material comprising a polyketone.

17. A fluid filter, comprising:
a housing formed from a material comprising a polyketone, said housing comprising:
a first housing section having a tubular inlet and having a first hollow shell in fluid communication with said tubular inlet;
a second housing section having a tubular outlet and a second hollow shell in fluid communication with said tubular outlet, said second housing section being joined to said first housing section; and
a filter element disposed within said housing for filtering a fluid therethrough; wherein said filter element is formed from a material comprising a polyketone.

18. The fluid filter of claim 17, wherein the filter element comprises at least one fluid-permeable membrane extending across a selected one of said first and second housing sections.

19. The fuel filter of claim 17, wherein said housing further comprises an electrically conductive material.

20. The fuel filter of claim 17, wherein said filter element comprises a porous block.

21. The fuel filter of claim 17, wherein said filter element comprises a multiplicity of plastic beads.

22. The fuel filter of claim 17, wherein said beads are held together in a fixed orientation thereof.

23. The fuel filter of claim 17, wherein said beads are loosely held within said housing.
